(19) United States
(12) Patent Application Publication
(10) Pub. No.: US 2015/0049590 A1
(43) Pub. Date: Feb. 19, 2015

(54) SUB-ARRAY TRANSDUCER APPARATUS AND METHODS

(71) Applicant: Row Technologies, Inc., Poway, CA (US)

(72) Inventors: Francis Rowe, Poway, CA (US); Marc Parent, Windham, NH (US)

(21) Appl. No.: 14/460,853

(22) Filed: Aug. 15, 2014

Related U.S. Application Data
(60) Provisional application No. 61/866,453, filed on Aug. 15, 2013.

(51) Int. Cl. G10K 11/26

(52) U.S. Cl. CPC G10K 11/26
USPC 367/138

(57) ABSTRACT

Apparatus and methods for creating transmit and/or receive beams within a fluidic medium. In one aspect, a series of sub-arrays are used to create a larger array capable of forming multiple transmit/receive beams. In one embodiment, a single sided electrode is disclosed, which provides among other things a technological alternative to prior art 2-dimensional array technologies for the purpose of producing multiple beams for applications such as Acoustic Doppler Current Profiling sonars or other 2D array sonar applications. In another embodiment, a dual-sided approach is used which advantageously requires reduced drive voltage(s) for the same output power.

### PRIORITY

This application claims the benefit of priority to co-owned U.S. Provisional Patent Application Ser. No. 61/866,453 of the same title filed Aug. 15, 2013, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Technological Field

The present disclosure relates to acoustics and in certain exemplary aspects to acoustic transducers and acoustic Doppler systems (such as Acoustic Doppler Current Profilers, or ADCPs) applied to aqueous channel fluid flow velocity and channel discharge measurement.

2. Description of Related Technology

Sonar transducers are currently used in different types of acoustic backscatter systems that measure velocity and/or distance in two or three dimensions. One such sonar transducer is disclosed in U.S. Pat. No. 5,808,967 to Yu, et al. issued Sep. 15, 1998 and entitled “Two-dimensional array transducer and beamformer” (hereinafter “the '967 Patent”), the contents of which are incorporated herein by reference in its entirety, which discloses an acoustic planar array transducer that forms multiple beams at a single or relatively narrow range of frequencies along two axes of a single two-dimensional (“2D”) phased array transducer. The '967 Patent discloses an acoustic array transducer whereby one pair of beams is formed by connecting a beamformer to a first set of electrodes on one side of the transducer and the other pair is formed by connecting a second beamformer to a second set of electrodes on the other side of the transducer. The electrodes on one side of the transducer run in the orthogonal direction relative to those on the other side of the transducer.

In order to simultaneously and independently form each pair of beams on both transmit and receive channels, two separate and independent transmit beamformers and two separate and independent receive beamformers are used. A transmit/receive switch is also used to connect one transmit beamformer and one receive beamformer to the electrical contacts on one side of the transducer. However, such an approach inherently necessitates a two sided electrode interconnection for Acoustic Doppler Current Profiling (“ADCP”) or other 2D array sonar applications, which can be problematic from manufacturing, cost, and operational/application perspectives. Specifically, manufacture of such 2-sided devices can be unduly complex and costly. Moreover, the operational voltages needed to drive such devices can be comparatively high, thereby adversely impacting both power consumption and personnel safety.

Accordingly, there is a salient need for transducer arrays that can provide at least comparable beamforming performance to that of the prior art (such as in the '967 Patent), yet with, for example, a simpler or more application-friendly technological approach. Ideally, such approach would provide for significantly reduced driving voltages (and hence power consumption) as well as provide for enhanced personnel safety and reduced design/construction requirements relating to handling lower applied voltages thereby providing, for example, enhanced durability for the components of such an improved transducer array system.

### SUMMARY

The present disclosure satisfies the foregoing need(s), and specifically relates in one exemplary aspect described herein, to a single-sided electrode technology that can be used, inter alia, as an alternative to or replacement for prior art two-sided row/column electrode interconnections for two-dimensional (2D) arrays, such as e.g., for the purpose of producing multiple (e.g., four (4) or more beams) for applications such as Acoustic Doppler Current Profiling sonars (ADCPs), or other 2D array applications using a single 2D phased array transducer having multiple Nₓ×N_{y} sub-arrays.

In another aspect of the disclosure, an acoustic system capable of forming multiple transmit and/or receive beams is disclosed. In one embodiment, the system comprises a planar transducer array having a plurality of substantially similar sub-arrays, each having a plurality (e.g., four-by-four (4×4)) of acoustic elements.

In another aspect, a method of constructing a single-sided method of electrical interfacing with sub-array elements is disclosed where one side of the sub-array elements are independently electrically connected, and the electrodes on second (2^{nd}) side are all connected in parallel with a common electrical plane, thus requiring 16 (plus a common) electrical interconnections for the four-by-four (4×4) sub-array.

In another aspect, a beamformer configuration is disclosed.

In a further aspect, a two-sided method of electrical interfacing with sub-array elements that are independently electrically connected on two sides is disclosed. In one variant, the transducer sub-arrays elements are interconnected on both sides of a planar array (e.g., with the same interconnection pattern). The applied and/or received signals on the two sides may be one-hundred eighty degrees) (180°) out of phase allowing for a differential electrical interface. This approach requires in the exemplary configuration 2Nₓ×2N_{y} electrical interconnections, but advantageously reduces the applied transmit (drive) voltage requirements by a factor of two on each side over a single sided transmit drive to achieve the same transducer array output power.

In another aspect of the 2-sided approach, many different applied AC voltages may be applied to each side, providing expanded flexibility relative to the single-sided approach.

In yet a further aspect, an acoustic apparatus is disclosed. In one embodiment, the apparatus includes at least one beamformer circuit; and an array of transducer elements comprising a repeated single-sided electrode (SSE) pattern.

In another embodiment, the apparatus includes at least one beamformer circuit; and an array of transducer elements comprising a dual-sided electrode pattern. The array of transducer elements is configured such that a first drive voltage applied to a first side thereof is out of phase with a second drive voltage applied to a second side thereof.

In yet another embodiment, the apparatus includes: a plurality of substantially identical N×N sub-arrays of transducer elements; and at least one transmit and receive beamformer. Each of the transducer elements within the plurality of sub-arrays are electrically interconnected together with one or more other transducer elements at its corresponding position within other ones of the substantially identical N×N sub-arrays.

### BRIEF DESCRIPTION OF THE DRAWINGS

The features, objectives, and advantages of the present disclosure will become more apparent from the detailed description set forth below when taken in conjunction with the drawings, wherein:

FIGS. 1-1i illustrates a plurality of exemplary (sample) phase patterns for one embodiment of a four-by-four (4×4) sub-array according to the disclosure.

FIGS. 2(a)-2(d) are graphical representations of an exemplary electrode pattern for the independent generation of each of a plurality (e.g., four (4)) acoustic beams, denoted as horizontal and vertical “I” beam array patterns (FIGS. 2(a) and 2(b), respectively), and horizontal and vertical “Q” beam array patterns (FIGS. 2(c) and 2(d), respectively).

FIG. 3 is a graphical representation of an exemplary electrode pattern for unique four (4) four-by-four (4×4) sub-arrays required for the generation of each of the plurality (e.g., four (4)) of acoustic beams of FIG. 2, denoted as “I” and “Q” in the horizontal and vertical planes, respectively.

FIG. 4 is a graphical representation of an exemplary summed electrode pattern configured to simultaneously generate a plurality (e.g., four (4)) ADCP transmit beams.

FIG. 5 is a graphical representation of an exemplary embodiment of a thirty-two by thirty-two (32×32) array consisting of multiple four-by-four (4×4) sub-arrays according to the present disclosure.

FIG. 6 is a graphical representation of an exemplary 2D array interconnect configuration using a two-sided (e.g., Red and Black) printed circuit board (“PCB”) to interconnect multiple four-by-four (4×4) sub-arrays with sixteen (16) interconnect lines.

FIG. 7 is a graphical representation of an exemplary 2D transducer array with twenty-four (24) four-by-four (4×4) sub-arrays and associated beamformers.

FIG. 8 is a graphical representation of an exemplary 2D sub-array transducer configuration. showing the various beams formed thereby.

All Figures disclosed herein are ©Copyright 2013-2014 Rowe Technologies, Inc. All rights reserved.

### DETAILED DESCRIPTION

### Overview

In one aspect, apparatus and methods for creating 2D transmit and/or receive beams within a fluidic medium from a planar transducer array composed of one or more identical sub-arrays is disclosed. In one embodiment, a single-sided electrode interconnection is disclosed which provides among other things a technological alternative to prior art two-sided row/column interconnected 2D array technologies for the purpose of producing multiple beams for applications such as ADCP sonars or other 2D array sonar applications. In another embodiment, a dual-sided electrode interconnection approach is used which advantageously requires reduced transmit drive voltage(s) for the same output power.

In another aspect, a large planar array transducer composed of multiple smaller, identical N×N planar arrays (sub-arrays) of transducer elements is disclosed. In one embodiment, all (i.e., N²) correspondingly positioned elements within the sub-arrays are electrically interconnected together over the entire area of the larger planar array transducer, and electrically combined in transmit and/or receive amplitude and phase-delay or time-delay beamforming networks. This configuration allows for, inter cilia, simultaneous or sequential formations of multiple narrow transmit and/or receive acoustic beams oriented in a variety of inclined axes/directions relative to the array face. This sub-array configuration may be used along with the single-sided electrode interconnection approach discussed above, or with a two-sided interconnection approach, thereby providing significant design flexibility.

### DETAILED DESCRIPTION OF EXEMPLARY IMPLEMENTATIONS

Reference is now made to the drawings wherein like numerals refer to like parts throughout.

### Sub-Arrays

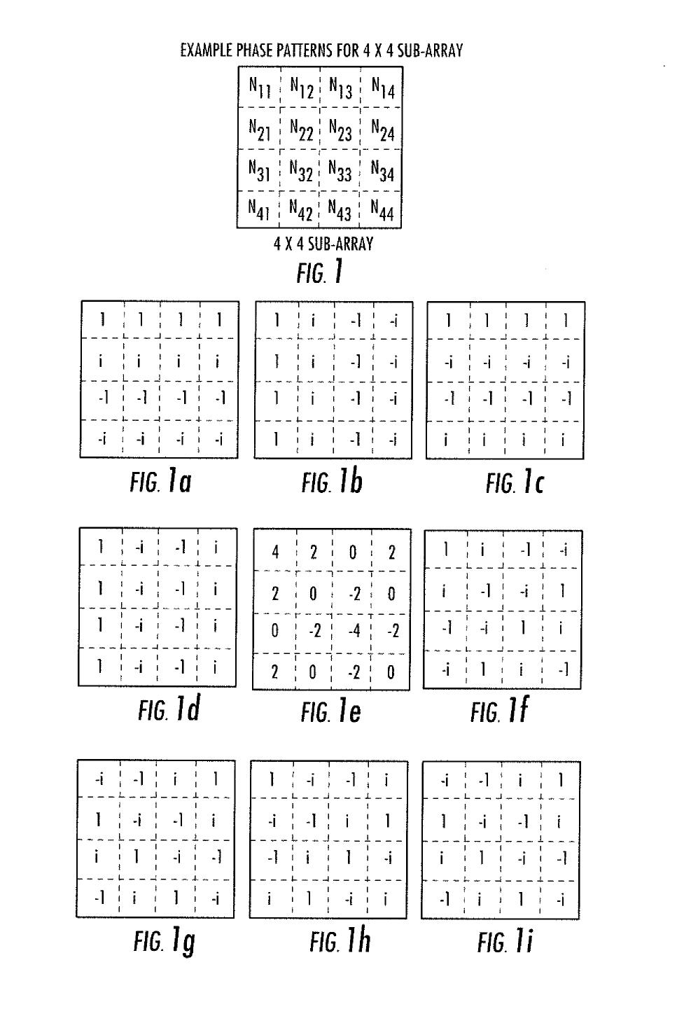

Referring now to FIGS. 1 through 1i, exemplary implementations of a sub-array based transducer apparatus according to the disclosure are described. The exemplary implementation of the sub-array generally comprises an N×N planar array of ultrasonic transducer elements which can form acoustic beams in a variety of directions. A larger planar array consisting of repeating groups (or sub-arrays) of N×N (e.g., N being divisible by four (4)) electrodes is formed from these sub-arrays. Hence, the exemplary configuration is largely “modular” in nature, such that more or less and different sub-arrays can be used based on the desired application. Each of the N×N sub-arrays have individual transducer elements which may be individually referred to as element Nᵢⱼ (wherein the indices i and j are integers with 1≦i≦N and 1≦j≦N). Moreover, each element Nᵢⱼ within each group (or N×N sub-array) of electrodes is electrically connected to element Nᵢⱼ in each other group (or N×N sub-array) of N×N electrodes. The transducer elements in the illustrated implementation are closely spaced at about a one-half (½) wavelength center-to-center spacing, although it will be appreciated that other dimensions and spacings may be used with success. These groups of sub-arrays are repeated in the illustrated embodiment to form the entire area of the planar array transducer face.

Accordingly, even with a relatively simple four by four (4×4) sub-array, nine (9) different acoustic beams can be formed by using different phase/time delays in the beamformers between the sixteen (16) sub-array elements present within this four by four (4×4) sub-array. To form inclined beams in the X and Y axes. the Y-axis elements are phased at 0, 90, 180, 270 degrees, and for Y-direction steering, the X-axis is phased similarly. True off-axis diagonal beams may be also formed when the diagonal axis elements are phased at 0, 90, 180, 270 degrees. Also, it will be appreciated that a beam normal to the X or Y axis may be formed by applying a single phase to all of the elements.

In general, for any repeating electrical beamforming pattern of Pₓ phases in one direction (X axis) and P_{y} phases in the orthogonal direction (Y axis), a repeated pattern can be formed from sub-arrays having Pₓ×P_{y} plus a common electrode(s). For the exemplary case of a 4-beam application, Pₓ=P_{y}=four (4), so four times four (4×4) equals sixteen (16) unique electrodes that are used on one side, plus a backside common electrode is required.

FIG. 1 shows an exemplary four by four (4×4) sub-array of each of the sixteen (16) electrodes (i.e., N₁₁ . . . N₄₄) of the previously discussed example, used to form eight (8) inclined transmit and/or receive beams. In the exemplary implementation, the sixteen (16) sub-array transducer element patterns are identical, but the sub-array electrical phasing patterns are unique for each beam and are repeated throughout the rest of a larger array.

FIGS. 1a and 1b show the electrode electrical (phase) pattern applied to each of the sixteen (16) electrodes to form Y-axis beams running in the X-axis direction only.

FIGS. 1c and 1d show the sixteen (16) electrode electrical phase pattern for the X-axis beams, running in the orthogonal Y-axis direction. Four transmit and/or receive X-axis and Y-axis beams may therefore be simultaneously formed with as few as sixteen (16) transmit and/or receive beamformers.

FIGS. 1f, 1g, 1h and 1i show the electrical electrode phase patterns for forming four (4) beams in the 2D diagonal direction.

Simplified variations of the sixteen (16) transmit drive configurations can also be achieved using the principle of linear superposition. By summing the individual electrode phase patterns for each of the four (4) individual transmit beams discussed supra, a composite electrode pattern is produced for simultaneous formation of four transmit X, Y axis beams. FIG. 1e shows the resulting sub-array electrode drive pattern, which includes two (2) unique phases and two (2) unique amplitudes, together with six (6) undriven (i.e., 0) electrodes.

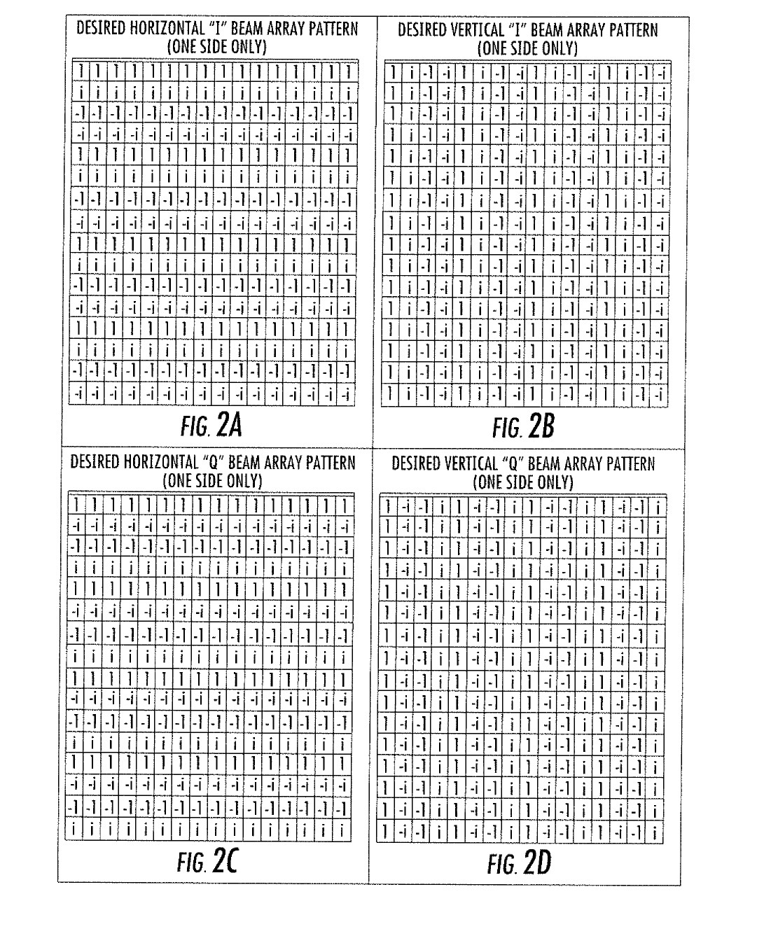

To illustrate how of a larger array composed of multiple sub-arrays to form four (4) orthogonal beams in the X, Y plane, an exemplary sixteen by sixteen (16×16) electrode pattern is shown in FIGS. 2a-2d, composed of identical four by four (4×4) sub-arrays. Since only the electrodes within the four by four (4×4) sub-arrays are unique to each beam, each electrode within any sub-array may be connected to the electrode in the same position within every other sub-array. Thus, for an exemplary larger square-shaped array with dimensions of 4Nₓ×4N_{y}, there will a total of Nₓ*N_{y} sub-arrays and sixteen (16) unique electrode electrical inputs (i.e. 4×4) for transmission, and likewise using the same sixteen (16) unique electrode outputs for receiving. In the illustrated example, the number of X-axis and Y-axis electrodes is arbitrary, and sixteen (16) is chosen only for the purposes of illustration. For example, for each of the sixteen (16) individual electrodes, one of four (4) transmit and/or receive phases (i.e. 0°, 90°, 180°, 270°) represented by 1, i, −1, and −i in FIGS. 2a-2d is used.

It will be appreciated that while the implementation of FIGS. 2a-2d discussed above is in the context of an exemplary single-sided electrode (SSE) wiring configuration (discussed in greater detail below), the principles of the present disclosure are in no way so limited. In fact, the sub-array technique described in the present disclosure may be used with a dual-sided electrode interconnection approach (e.g., where the second side is interconnected by a single plane (single-sided) or multiple (2 or more) interconnections, and hence the SSE approach is purely illustrative.

### Single Side Electrode Configuration—

The exemplary “single sided electrode” or SSE technology referenced above and described herein makes use of, inter alia, recognition that the orthogonal first side row and second side column electrode interconnection configuration (as documented in the prior art; see, e.g., the '967 Patent, previously incorporated herein by reference in its entirety) can be replaced by a sub array electrode interconnection pattern on, e.g., multiple electrode connections on one side of the transducer only. Unlike many typical single beamformer approaches, the SSE approach can advantageously provide simultaneous and independent beamforming along multiple 2D axes. For the exemplary case of a fixed 4-beam sonar, the number of required transmit and/or receive channels is sixteen (16). SSE may be combined with, for instance, the small, low power sixteen (16) channel transmitter and receiver being developed by the Assignee hereof, and that may be easily stacked to accommodate the aforementioned more transmit/receive channels. Various other combinations and configurations will be recognized by those of ordinary skill when given this disclosure.

In comparison with the prior art two sided electrode approach where a total of 2Nₓ*2N_{y} channels are required, the exemplary embodiment of the SSE approach of the present disclosure requires Nₓ*N_{y} channels. Thus, an exemplary 4-beam transducer implemented using four (4) phases in the X dimension, and four (4) phases in the Y dimension, requires eight (8) channels using prior art implementations, and in contrast requires sixteen (16) channels in the exemplary SSE implementation

FIGS. 2(a)-2(d) illustrate on approach of how four (4) ADCP beams can be generated via a unique SSE pattern (i.e., multiple independent connections on one side of the transducer, and a solid common ground electrode spanning the entire array on the other side).

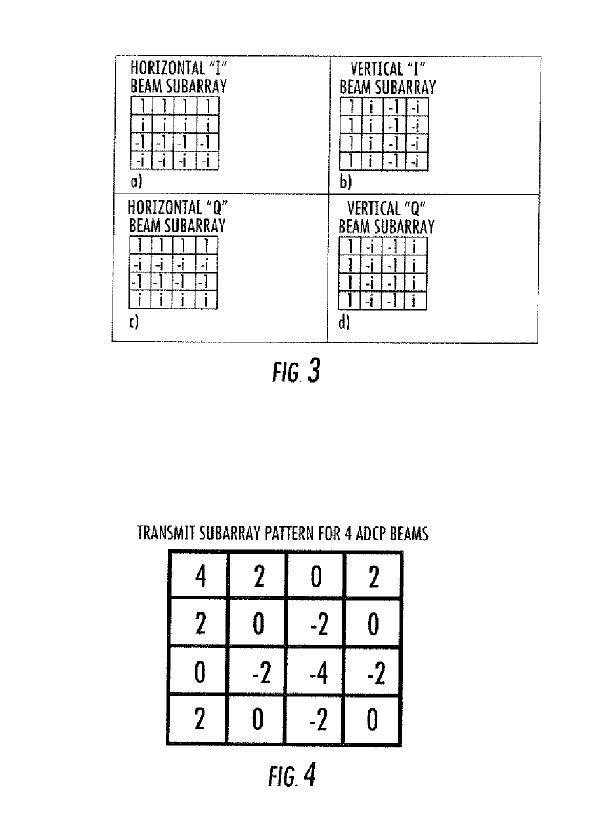

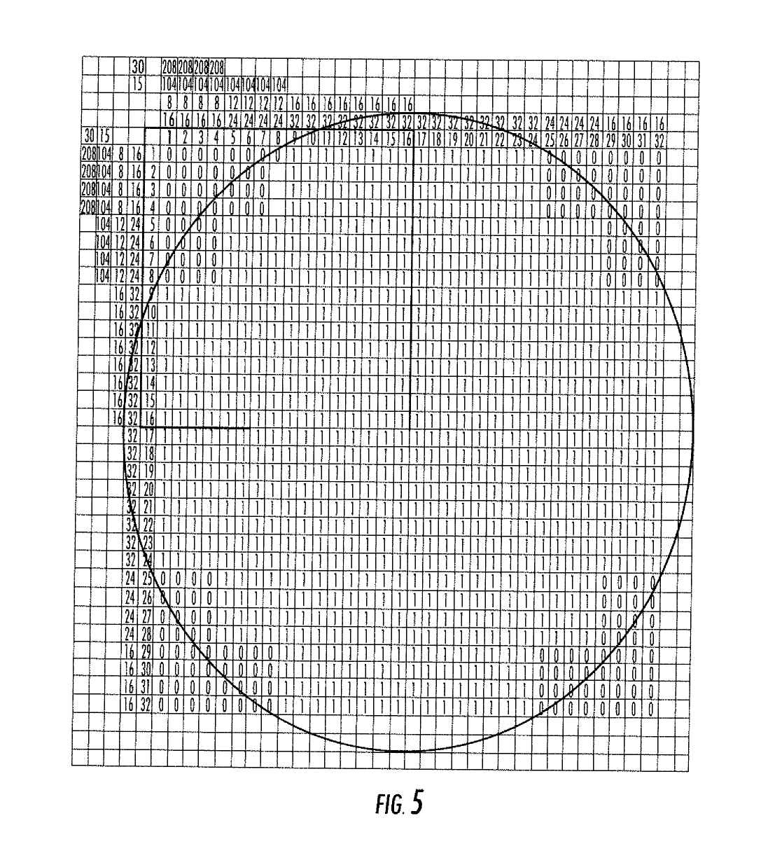

FIG. 3 shows a four by four (4×4) sub-array of each of the required electrode excitation patterns (taken from FIG. 2, for each of the four (4) desired ADCP beams). The sub-arrays are unique, and they are repeated throughout the rest of a larger array. FIGS. 2(a)-2(d) and FIG. 3 also show that the same four by four (4×4) sub-array electrode pattern is used for each of the four (4) beams. For example, for each of the four (4) ADCP beams the sixteen by sixteen (16×16) electrode patterns in FIGS. 2(a)-2(d) is composed of identical four by four (4×4) sub-arrays from FIG. 3. Since the electrode electrical interface to all four by four (4×4) sub-arrays are identical to produce each beam, each electrode within any sub-array may be connected to the electrode in the same position within every other sub-array. Thus, for any size 2D array with dimensions of 4Nₓ rows and 4N_{y} columns. there will a total of Nₓ by N_{y} sub-arrays and only sixteen (16) unique electrodes (i.e. 4×4) are required for the transmit and receive function.

In a more general view of the approach, for any repeating beamforming pattern of Pₓ phases in one direction (rows) and P_{y} phases in the orthogonal direction (columns), a repeated single-sided electrode (SSE) pattern can be formed from sub-arrays having Pₓ by P_{y} electrodes. For the case of the 4-beam ADCP application, Pₓ=P_{y}=four (4), and so sixteen (16) unique electrodes are required.

A simplified variation of the transmit requirements for the SSE approach can also be achieved using the principle of linear superposition. By summing the individual electrode patterns for each of the four (4) individual transmit beams, a composite electrode pattern is produced for simultaneous generation of all four (4) ADCP beams. FIG. 4 shows the resulting sub-array electrode pattern, which includes two (2) unique phases and two (2) unique amplitudes, together with six (6) undriven electrodes. The four (4) ADCP beams may therefore be simultaneously generated with as few as four (4) transmit drivers. Note that in the configuration of FIG. 4, two (2) unique phases and two (2) amplitudes are required, and the highlighted electrodes need not be driven at all.

FIGS. 2(a)-2(d) and FIG. 3 further illustrate how the two pairs of orthogonal beams can be formed using the SSE approach. FIGS. 2(a)-2(d) illustrate a small 2D array with sixteen (16) rows and sixteen (16) columns of electrodes, and also show the required 2D electrode excitation patterns for generation of each of the four (4) ADCP beams. In the illustrated example, the number of rows and columns is arbitrary (sixteen (16) is chosen only for the purposes of illustration herein). Each individual electrode is driven by one of four (4) phases (i.e., 0°, 90°, 180°, 270°) represented by 1, i, −1, and −i in FIGS. 2(a)-2(d) and FIG. 3. From FIGS. 2(a) and 2(b), the electrode electrical signal pattern for the horizontal beams runs in one direction only, and from FIGS. 2(c) and 2(d), the electrode electrical signal pattern for the vertical beams run in the orthogonal direction.

For the receive sub-arrays, reducing the number of unique electrode electrical signals is not possible since the beams must be formed independently rather than simultaneously in order to differentiate signals from each of the 4 directions. It may however be possible to reduce the total number of receive channels by linearly combining the outputs of electrodes ahead of the receive channels. For example, only four (4) electrode combination outputs is required

It is noted that in comparison with the prior art single beamformer technology previously referenced, the SSE approach generally requires additional transmit and receive channels (unless channels are multiplexed). However, the SSE approach also advantageously affords the possibility of grounding one side of the phased array transducer, which provides at least the following advantages:
1) improved transducer and receiver system shielding against electrical interference;
2) reduced transducer electrode requirements (e.g., only one flex circuit is required);
3) potentially simplified transducer assembly (e.g., since only one flex circuit is required); and
4) easier generalization to arbitrary 2D beamforming. For example, by applying equivalent phases (i.e., the same 0°, 90°, 180°, 270° pattern) on the diagonal, a beam offset may be electrically steered by forty-five degrees (45°). The diagonal offset beam will not be thirty degrees (30°) from broadside however, it will actually be some other value, such as e.g., roughly forty-five degrees) (45°) (i.e., root (2)*thirty degrees (30°)) from broadside or fractions thereof (e.g., root (2)*thirty degrees (30°)/2 or roughly 21 degrees), depending on the particular implementation.

FIG. 5 illustrates how an exemplary 2D thirty-two by thirty-two (32×32) element array (which approximates a circle) can be configured to generate four (4) beams in the X and Y axes, and inclined relative to the axis which is orthogonal to the array. The entire illustrated embodiment of the array consists of four by four (4×4) sub-arrays.

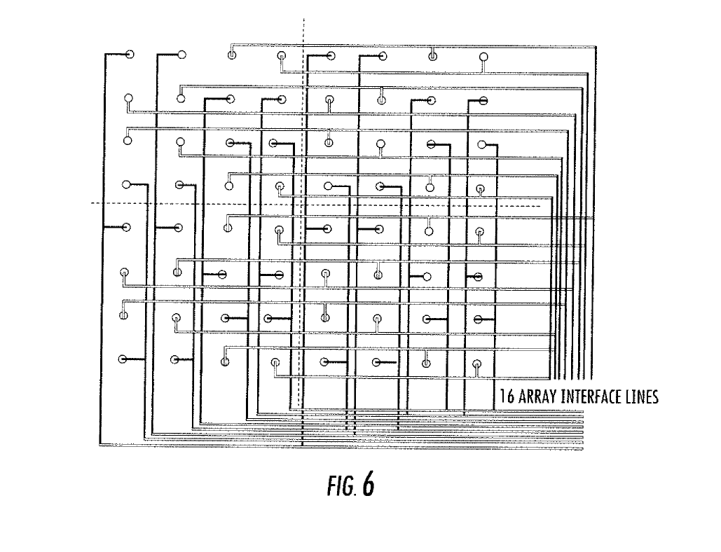

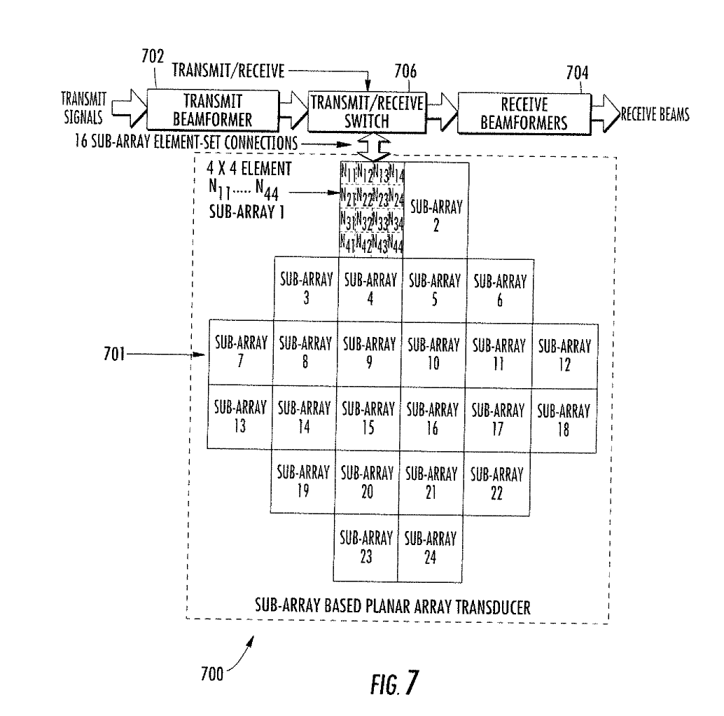

FIG. 6 illustrates another embodiment of the SSE technique of the disclosure; i.e., a possible one-sided array interconnect using a two-sided PCB electrically connected to all of the array elements. In the exemplary wiring diagram of FIG. 6, the electrical interconnections are formed on a two-layer interconnect for four (4) repeated four by four (4×4) groups of electrodes. This interconnect pattern may be, for example, disposed on only one side of the array (with the sub-array pattern), with connection of the other side to a common ground spanning the entire array, although other approaches may be used.

Although the single-sided transmit/receive configuration offers advantages over a two sided drive (as outlined above), it should also be noted that, if desired, both sides of the transducer can be identically configured with electrodes with the same sub-array pattern instead of configuring one side with electrodes in the sub-array pattern, and connecting the other side to a common ground spanning the entire array.

As an illustration of the exemplary method of 2D beamforming using four by four (4×4) cells, consider a four by four (4×4) cell array with four phases (e.g., 0°, 90°, 180°, 270°) for steering in the X direction. In this case, the phase in each column in the cell is constant. A larger N×N array (where N is divisible by 4) would then just repeat this four by four (4×4) cell in both the X and Y directions.

For steering in the Y direction, the phase in each row in the four by four (4×4) cell array is constant. And again, a larger N×N array can be built from additional concatenated four by four (4×4) cell arrays in the X and Y directions.

Thus, any N×N array (N divisible by 4) with four (4) phases for beamforming can be wired in four by four (4×4) cell arrays, (i.e., sixteen (16) unique transmit and receive channels, with channel one connected to all elements at location 1, 1; channel two connected to all elements at cell location 1, 2, and so forth). For X direction steering, the columns can be phased as 0°, 90°, 180°, 270°, and for Y direction steering the rows can be phased similarly. The formed X and Y beams are therefore functionally no different than those produced with a transducer having columns on one side and rows on the other.

However using the sub-array based approach described herein, it is also possible to form off-axis beams using e.g., four by four (4×4) sub-arrays, such that for the phase pattern of 0°, 90°, 180°, 270°, four (4) additional diagonal beams, as well as a center beam, can be generated. From the cell patterns, specific channels may be electrically combined differentially, to increase the electrode electrical sensitivity. An exemplary implementation includes eight by eight (8×8) elements per sub-array, and eight squared (8²)=sixty-four (64) transmit and receive channels that are required.

The exemplary embodiment of the single sided cell based approach disclosed herein requires M*M/2 channels for M phases in the beamformer phase pattern. The two-sided row and column approach by contrast requires (M+M)/2 channels.

As noted above, the sub-array based 2D planar transducer of the present disclosure can be configured with all sub-arrays connected on one side and a common conducting plane on the other side, or with the same interconnect pattern of sub-array elements on both sides.

If interconnected on one side relative to a common plane on the second side, for transmit operation, the applied voltage drive of the exemplary embodiment with an root mean square (RMS) AC voltage equal to V, The output power per sub-array will be V²/R, where R is the resistance of each sub-array. Alternatively, if interconnected on both sides (e.g., with the same interconnection pattern), the transmit AC voltage drive (V) on one side of each sub-array electrode is applied while the other side may be driven by an AC voltage which is out of phase with the first side, resulting in a total differential voltage of 2V. The output power for this exemplary implementation will be increased by a factor of 2²=four (4). One salient advantage of the foregoing configuration is that a given drive power level (and corresponding acoustic transmit power level), may be achieved with an AC voltage level that is a factor of two (2) lower than when using a typical prior art configuration. This improvement can be very important in sonar applications, because the higher voltages necessitated by prior art approaches create practical design and safety limitations. Stated differently, the exemplary embodiment described supra can provide comparable beamforming performance to that of the prior art, yet with significantly reduced driving voltage (and hence power consumption), enhanced personnel safety, and reduced design/construction requirements relating to handling lower applied voltages (including enhanced durability for the components).

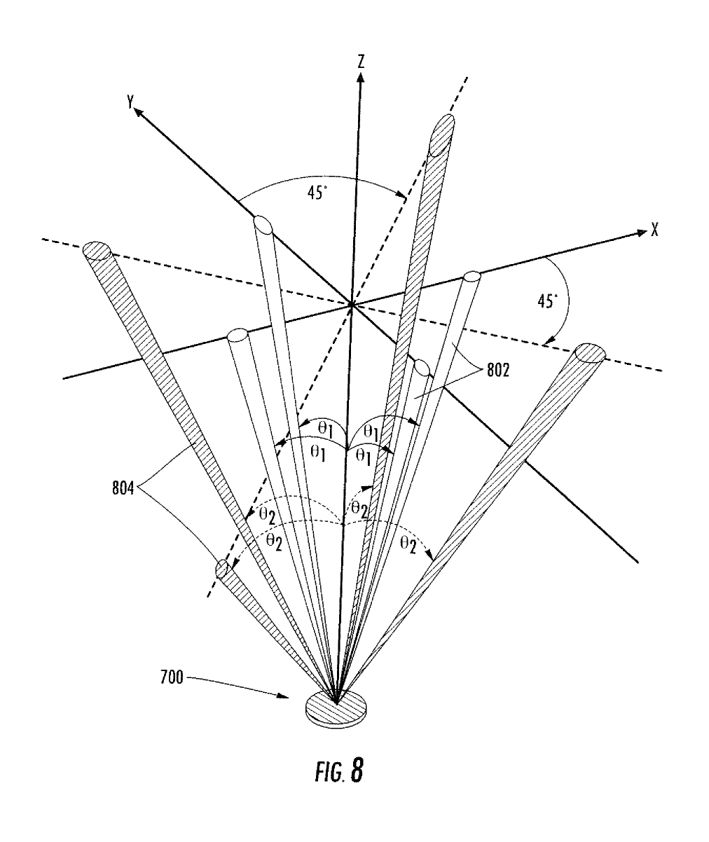

Referring now to FIG. 7, a block diagram of yet another exemplary embodiment of an apparatus 700 having a larger array 701 and associated transmit/receive beamformers 702, 704 for forming narrower beams composed of twenty-four (24) identical four by four (4×4) element sub-arrays (N₁₁ . . . N₄₄) is shown. During transmit mode operation, the transmit beamformer 702 electrically applies phase-delays or time-delays to each of the electrically independent sub-array signals to form multiple transmitted acoustic beams in the 3D (e.g., X,Y,Z) plane, where Z is normal to the X,Y plane. During receive mode operation, a receive beamformer 704 electrically applies phase-delays or time-delays to each of the N² electrically independent sub-array signals to form an identical set of receive beams. A switch 706 is utilized in this apparatus 700 to switch between the transmit/receive beamformers, although it will be appreciated that other configurations may be used consistent with the present disclosure.

FIG. 8 illustrates dual sets of exemplary narrow acoustic beams generated by the apparatus 700 with larger array of multiple sub-arrays of FIG. 7. If the sub-array elements are center-to-center spaced at one-half (½) wavelength, a first set of four (4) beams 802 is formed (oriented along the X, Y axis plane and inclined 30° (θ₁ in FIG. 8) relative to the Z axis). A second set of four (4) beams 804 oriented in ninety-degree (90°) angle increments at forty-five degrees (45°) relative to the X, Y axis plane and inclined forty-five degrees (45°) (θ₂ in FIG. 8) relative to the Z axis is formed as well. Other angles/numbers of beams may be formed as well consistent with the disclosure, those of FIG. 8 being merely illustrative.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure.

What is claimed is:

1. Acoustic apparatus, comprising:
at least one beamformer circuit; and
an array of transducer elements comprising a repeated single-sided electrode (SSE) pattern.

2. The acoustic apparatus of claim 1, wherein the repeated SSE pattern is configured to produce four (4) or more acoustic beams.

3. The acoustic apparatus of claim 2, wherein the repeated SSE pattern is comprised of a plurality of sub-arrays of transducers, each sub-array of transducers is comprised of a row of X transducers and a column of Y transducers such that each transducer within a sub-array can be characterized as an N_{XY} transducer.

4. The acoustic apparatus of claim 3, wherein each transducer within a given sub-array has a unique connection with respect to other transducers within the given sub-array on a first side of the array of transducer elements and wherein each transducer is coupled to a common connection on a second side of the array of transducer elements.

5. The acoustic apparatus of claim 4, wherein the unique connection for each N_{XY} transducer within a first sub-array is coupled to another unique connection for each N_{XY} transducer within a second sub-array.

6. The acoustic apparatus of claim 5, wherein the repeated SSE pattern is configured to provide simultaneous and independent beamforming along each row and/or each column.

7. The acoustic apparatus of claim 2, wherein a number of transmit channels required for the at least one beamformer circuit is X and the number of receive channels for the at least one beamformer circuit is X².

8. Acoustic apparatus, comprising:
at least one beamformer circuit; and
an array of transducer elements comprising a dual-sided electrode pattern;
wherein the array of transducer elements is configured such that a first drive voltage applied to a first side thereof is out of phase with a second drive voltage applied to a second side thereof.

9. The acoustic apparatus of claim 8, wherein the first drive voltage is one-hundred eighty degrees (180°) out of phase with the second drive voltage, such that a differential voltage comprising the sum of the first and second drive voltages is produced.

10. The acoustic apparatus of claim 9, wherein the first drive voltage comprises a voltage of Vᵣₘₛ*Cos(2*pi*w*t), and the second drive voltage comprises a voltage of Vᵣₘₛ*(−Cos(2*pi*w*t)), thereby resulting in a total differential drive voltage of 2*Vᵣₘₛ*Cos(2*pi*w*t).

11. An acoustic apparatus, comprising:
a plurality of substantially identical N×N sub-arrays of transducer elements; and
at least one transmit and receive beamformer;
wherein each of the transducer elements within the plurality of sub-arrays are electrically interconnected together with one or more other transducer elements at its corresponding position within other ones of the substantially identical N×N sub-arrays.

12. The acoustic apparatus of claim 11, wherein a first row within one of the plurality of substantially identical N×N sub-arrays of transducer elements is driven at a different phase from a second row within the one N×N sub-array of transducer elements.

13. The acoustic apparatus of claim 12, wherein the first row within the one of the plurality of substantially identical N×N sub-arrays of transducer elements is driven at a different phase from a third row within the one N×N sub-array of transducer elements.

14. The acoustic apparatus of claim 13, wherein the first row within the one of the plurality of substantially identical N×N sub-arrays of transducer elements is driven at a different phase from a fourth row within the one N×N sub-array of transducer elements.

15. The acoustic apparatus of claim 14, wherein each of the first, second, third and fourth rows are each driven at a different phase than other ones of the rows.

16. The acoustic apparatus of claim 15, wherein the different phase is an integer multiple of ninety degrees (90°).

17. The acoustic apparatus of claim 11, wherein each of the transducer elements within the plurality of sub-arrays are electrically interconnected together with the one or more other transducer elements at its corresponding position within the other ones of the substantially identical N×N sub-arrays at a first side of the plurality of substantially identical N×N sub-arrays of transducer elements.

18. The acoustic apparatus of claim 17, wherein each of the transducer elements within the plurality of sub-arrays are electrically interconnected with one another at a second side of the plurality of substantially identical N×N sub-arrays of transducer elements.

19. The acoustic apparatus of claim 18, wherein the electrical interconnection on the second side is configured to provide improved shielding against electrical interference.

20. The acoustic apparatus of claim 19, wherein a first column within one of the plurality of substantially identical N×N sub-arrays of transducer elements is driven at a different phase from a second column within the one N×N sub-array of transducer elements.
